(19) United States
(12) Patent Application Publication
(10) Pub. No.: US 2008/0208624 A1
(43) Pub. Date: Aug. 28, 2008

(54) METHODS AND SYSTEMS FOR PROVIDING CLINICAL DISPLAY AND SEARCH OF ELECTRONIC MEDICAL RECORD DATA FROM A VARIETY OF INFORMATION SYSTEMS

(75) Inventors: Mark Morita, Arlington Heights, IL (US); Steven Lawrence Fors, Chicago, IL (US); William Douglas Hughes, Bainbridge Island, WA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/754,020

(22) Filed: May 25, 2007

Related U.S. Application Data
(60) Provisional application No. 60/891,174, filed on Feb. 22, 2007.

(51) Int. Cl. G06Q 50/00

(52) U.S. Cl. 705/2

(57) ABSTRACT

Certain embodiments of the present invention provide methods and systems for providing clinical display and search of electronic medical data from a variety of information systems. Certain embodiments provide a user interface system including a processor aggregating data relating to a patient from a plurality of information systems to form an aggregated electronic patient record; a filter focusing the aggregated data based on one or more criteria; and an output providing the focused data to a user. Certain embodiments provide a method for electronic patient data aggregation including aggregating data for a patient from a plurality of systems without individual manual login by the user at each of the plurality of systems; filtering the aggregated data based on one or more user-defined criteria entered through a unified interface to provide a filtered subset of the aggregated data; and displaying the aggregated data via the unified interface.

### RELATED APPLICATIONS

This application claims priority to provisional application Ser. No. 60/891,174, filed on Feb. 22, 2007, entitled “Methods and Systems for Providing Clinical Documentation for a Patient Lifetime in a Single Interface,” which is herein incorporated by reference in its entirety.

### FEDERALLY SPONSORED RESEARCH OR DEVELOPMENT

[Not Applicable]

### MICROFICHE/COPYRIGHT REFERENCE [Not Applicable]

### BACKGROUND OF THE INVENTION

The present invention generally relates to aggregating and viewing patient data. More particularly, the present invention relates to methods and systems providing clinical display and search capabilities for all of a patient's electronic medical record data from a variety of disparate information systems.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems. Personnel in a healthcare facility must manage a plurality of patients, systems, and tasks to provide quality service to patients. Healthcare personnel may encounter many difficulties or obstacles in their workflow.

Healthcare has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan.

Different clinical departments and different clinical systems gather patient information in different ways and in different forms and often separately store that information. The information must then be retrieved and viewed from several disparate systems.

Current information and management systems do not offer interconnection and flexibility. Current clinical information systems are typically modified manually by programmers for particular users. Many components of a patient care or practice management workflow are paper-based or not present at all. Current systems do not provide a central system by which a user may access and interrelate patient information, resource information, orders, and results. Many third party vendors providing a variety of solutions also present difficulties regarding interoperability and connectivity.

Currently, relevant patient information for a patient's entire lifetime exists in a number of formats that include paper, folders and disparate information systems from a variety of vendors and a variety of healthcare providers. Current systems cannot aggregate this information effectively. Additionally, current systems cannot display this information at one time so that healthcare providers have the ability to interpret a patient's complete medical history when assessing and diagnosing illnesses. Providers are rarely able to see the full history of a patient. More commonly, providers have only the information that they have gathered or that they have received in response to questions asked of the patient in a clinical setting. Key decisions are made with the limited knowledge available to the provider at the point at which the provider is making a decision.

Thus, systems and methods aggregating electronic medical record data from a plurality of disparate sources would be highly desirable. Systems and methods facilitating clinical display and search capabilities over a variety of disparate information systems would be highly desirable.

### BRIEF SUMMARY OF THE INVENTION

Certain embodiments of the present invention provide methods and systems for providing clinical display and search of electronic medical data from a variety of information systems.

Certain embodiments provide a user interface system displaying an electronic patient record. The system includes a processor aggregating data relating to a patient from a plurality of information systems to form an aggregated electronic patient record. The system also includes a filter focusing the aggregated data based on one or more criteria. The system further includes an output providing the focused data to a user.

Certain embodiments provide a method for electronic patient data aggregation. The method includes aggregating data for a patient from a plurality of systems without individual manual login by the user at each of the plurality of systems. The method also includes filtering the aggregated data based on one or more user-defined criteria entered through a unified interface to provide a filtered subset of the aggregated data. The method further includes displaying the aggregated data via the unified interface.

Certain embodiments provide a computer readable medium having a set of instructions for execution on a computer. The set of instructions includes a user interface routine displaying an aggregated electronic patient record. The electronic patient record includes a plurality of data points related to a patient. The plurality of data points provides patient data aggregated from a plurality of information sources. The user interface routine providing access to and review of the plurality of data points within a single view. The set of instructions also includes a filter routine filtering the aggregated electronic patient record based on one or more terms provided by a user to generate filtered electronic patient record data displayable via the user interface routine.

### BRIEF DESCRIPTION OF SEVERAL VIEWS OF THE DRAWINGS

FIG. 1 illustrates an exemplary display of a patient's full electronic medical record data points in accordance with an embodiment of the present invention.

FIG. 2 illustrates exemplary views provided with patient report data in a single interface in accordance with an embodiment of the present invention.

FIG. 3 illustrates exemplary views provided with patient report data in a single interface in accordance with an embodiment of the present invention.

FIG. 4 illustrates a flow diagram for a method for documentation of a patient lifetime in a patient record according to an embodiment of the present invention.

FIG. 5 illustrates a system for clinical data storage and retrieval in accordance with an embodiment of the present invention.

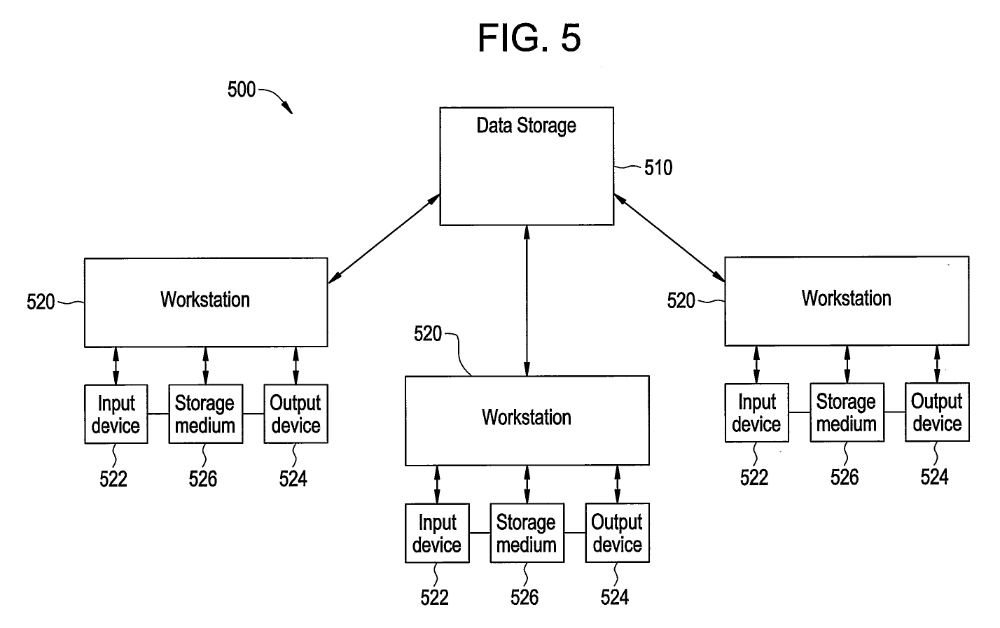

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods facilitating full clinical display and search of a patient's electronic medical record data from a variety of disparate information systems. In certain embodiments, a worklist or browser queries one or more enterprise hospital information systems. The worldist or browser aggregates the queried data into a single, interactive window that displays the results and data points from a particular patient search.

In certain embodiments, the worklist/browser can display information from systems such as Radiology, Cardiology, Pharmacy, Medication, and Lab information systems as well as Picture Archiving and Communication systems and/or other clinical information systems. Current systems do not allow flexibility and breadth in connected and queried information systems.

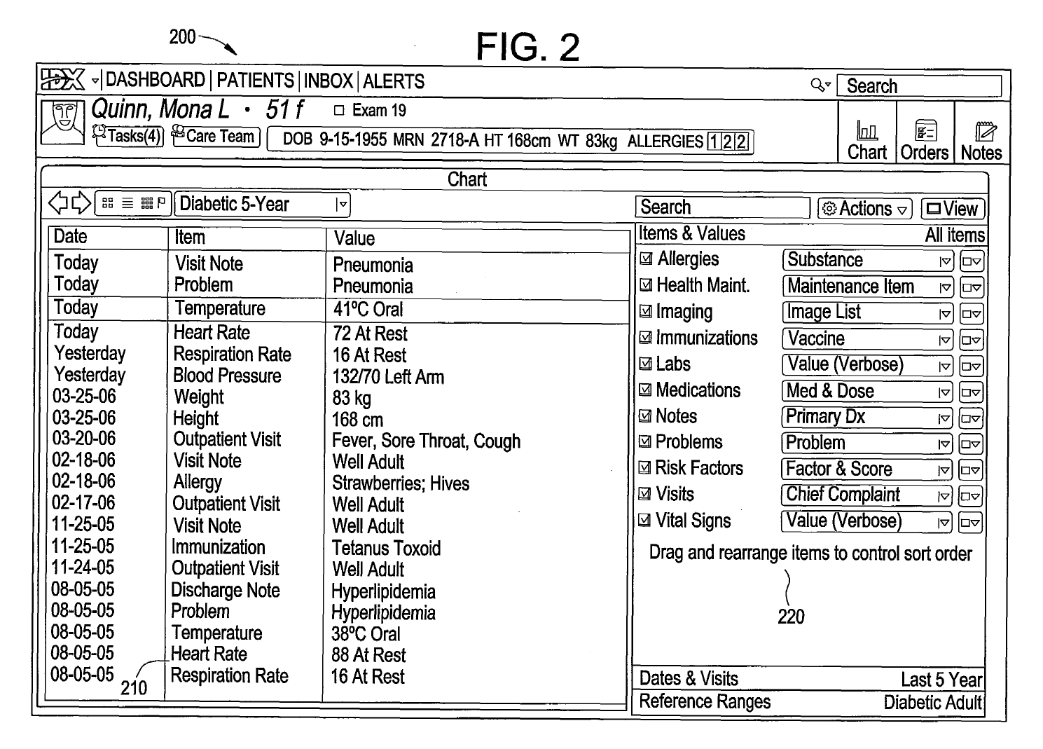

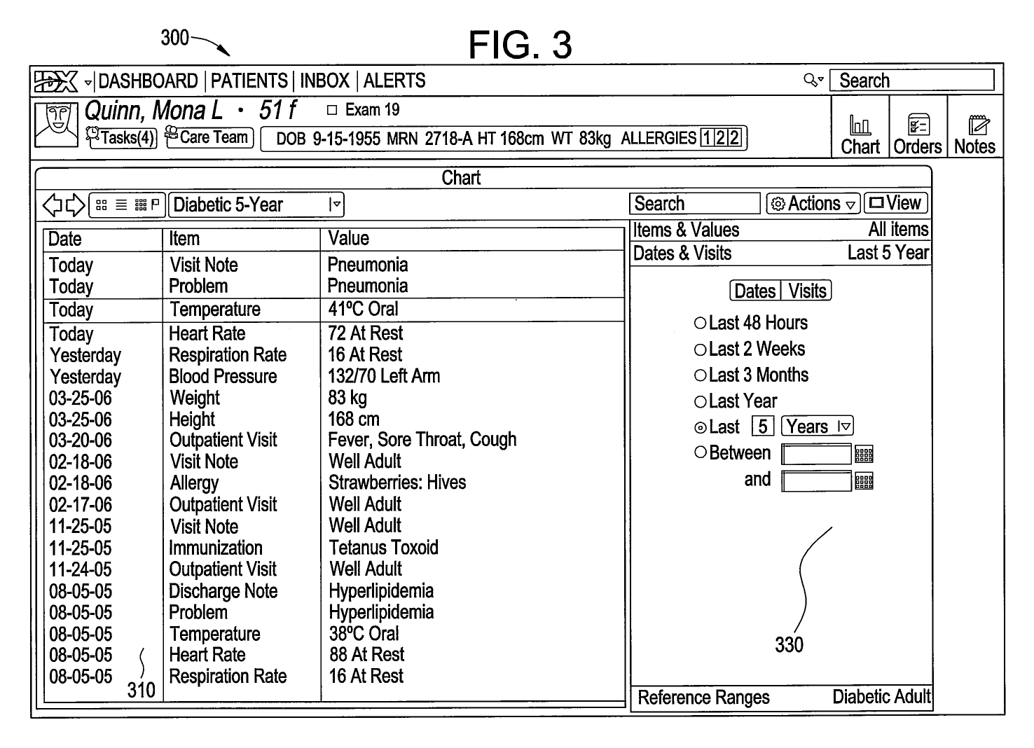

In certain embodiments, search results may be provided in column and row format (e.g., a table, spreadsheet, and/or other record format). Column headings of the searches can be user configurable to display metadata relevant to specific users. For example, as shown in FIGS. 2 and 3, columns may be configured by a user to display information regarding items and values and dates and visits. Column headings can be used to filter the patient information via dynamic keystrokes, for example. Alternatively and/or in addition, specific drop down menus related to each column heading may be provided to a user to focus and/or otherwise configure display and/or use of search results information.

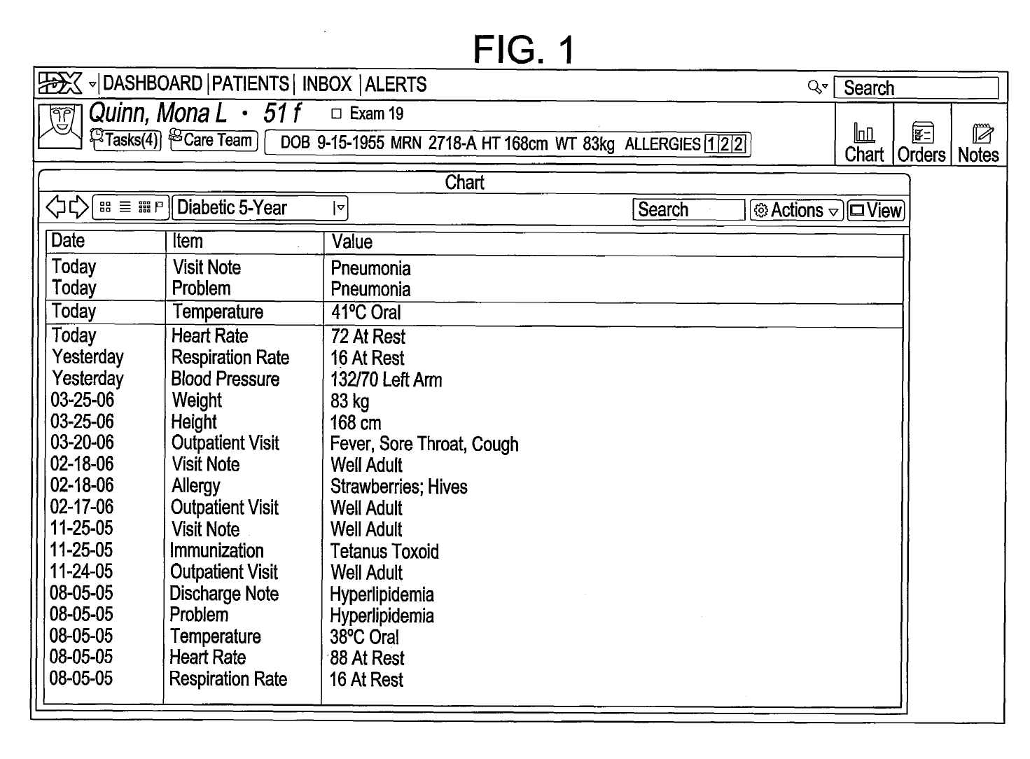

FIG. 1 illustrates an exemplary display of a patient's full electronic medical record data points in accordance with an embodiment of the present invention. Medical record data may be organized for a patient according to a plurality of columns organizing data points according to a default, a report/information type and/or user profile/preference, for example.

As shown in FIG. 2, a variety of views may be provided with the report data 210 in a single interface 200. For example, an Items and Values window 220 in a right hand column of the data display allows users to filter the specific types of EMR patient data for display. As illustrated, for example, in FIG. 3, a Dates and Visits window 330 in the right hand column allows users to filter the data points 310 based on dates and/or date ranges.

In certain embodiments, instead of and/or in addition to display of data in a tabular or column-based format, patient data may be displayed in a timeline or chronological format integrated and/or separated based on category/type of information, for example.

Using the search results browser or interface, a user, such as a clinician, is provided with an ability to search and filter a patient's full electronic medical record so as to visualize a full context to a patient's health or pathology, for example. In certain embodiments, a single or unified display system that allows the display of a patient's complete electronic medical record at one time. Certain embodiments allow a user to visualize patient medical data from a single workstation and/or interface without having to log in to multiple workstations. For example, data is automatically retrieved and aggregated in advance and/or on request through communication with a plurality of underlying systems for display via a single interface. Having all the data accessible at one time also allows a user to display and visualize the data in a variety of informative layouts.

In certain embodiments, patient data search results may be filtered in one or more ways. For example, the interface may allow filtering based on type of data. Filtering may be based on user-defined metadata driven columns. Data may also be filtered based on a date and/or time range, for example. Furthermore, data may be filtered based on patient visit (e.g., last patient visit, last five visits, last “N” visits, etc.).

Certain embodiments provide methods and systems providing comprehensive clinical documentation for a patient's entire lifetime in one interface. Certain embodiments enable a patient's entire medical history to be displayed, edited and interacted within one context. Users may view an entire gestalt of a patient history or timeline at a high level to better understand an overall health of a patient. From a high level overall vantage point, the user may navigate to any specific item on the patient's history by using a navigational cursor, mouse click, touch screen, voice command, gaze tracking, etc. The user can drill down to isolated metadata in the timeline to view specific lab reports, physical exam notes, procedures, etc. Thus, a user can navigate a complete set of patient healthcare data via a unified interface by scrolling, dragging, expanding, shrinking, etc., via the interface.

A patient EMR and/or other record include a medical history for a patient and include data with time stamps (or times and dates at which data was collected or entered). Types of data may include test names, test results, imaging procedures, medical visits (e.g., hospital, office, clinic, etc.), medical problem, caregiver encounter, medical procedure, symptoms, biological analysis, finding, medication, acquisition, etc. These types/categories of data can each be represented by a symbol on a common and/or individual timeline for each event of the data occurrence, for example.

In certain embodiments, EMRs can present data in visual manner by presenting a timeline with symbols representing each patient encounter. A patient encounter can include any test, visit, or other encounter with any physician, nurse, radiologist, image technician or other caregiver, for example. With many patient encounters, the timeline can get too cluttered and difficult to visualize associations between data. Data can be associated in a number of ways, such as by patient encounter (e.g., office/hospital visit/stay), time/date range, problem (e.g., diabetes, heart disease, broken bone, etc.), procedure (e.g., surgery, series of lab tests, etc.), collecting/entering hospital/clinic/caregiver, etc.

In certain embodiments, a rendering engine may “chart” or map aggregated data into a single timeline interface. As new data is collected, the rendering engine can “redraw” the timeline and update the interface.

In certain embodiments, a patient would not only own his or her own data, but would have an ability to share data with any healthcare provider, payer, clinical trial, etc. For example, a patient's data may be routed to another application, database, information system, portable medical record, etc.

In certain embodiments, comprehensive patient data points may be aggregated into a single location (e.g., a thumbdrive, CD, DVD, hard drive, etc.). Export capability from a plurality of clinical applications allows aggregation and storage of information to a single locale.

In certain embodiments, a patient medical record aggregated information from a plurality of information systems under a common patient context. Information systems may include a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An interface facilitating access to the patient record may include a context manager, such as a clinical context object workgroup (CCOW) context manager and/or other rules-based context manager. Components may communicate via wired and/or wireless connections on one or more processing units, such as computers, medical systems, storage devices, custom processors, and/or other processing units. Components may be implemented separately and/or integrated in various forms in hardware, software and/or firmware, for example.

Certain embodiments may be used to provide an integrated solution for application execution and/or information retrieval based on rules and context sharing, for example. For example, context sharing allows information and/or configuration options/settings, for example, to be shared between system environments. Rules, for example, may be defined dynamically and/or loaded from a library to filter and/or process information generated from an information system and/or an application.

Information for a particular patient may be extracted and/or linked from one or more information systems for presentation to a user via a unified patient record timeline, for example. In certain embodiments, information retrieval, display and/or processing settings, for example, may be customized according to a particular user or type of user. Retrieval, aggregation, display and/or processing of information may be based on rules, preferences, and/or other settings, for example. Rules, preferences, settings, etc. may be generated automatically based on preset parameters and/or observed data, for example. Rules, preferences, settings, etc., may be created by a system administrator or other user, for example. Rules, preferences, settings, etc., also may be manually and/or automatically adapted based on experiences, for example.

In certain embodiments, a user may log on any one of the connected systems and/or a separate system to access information found on all of the connected systems through context sharing and a unified user interface. In certain embodiments, information may be filtered for easier, more effective viewing.

In certain embodiments, a user interface providing a patient record may work together with a perspectives management system for handling multiple applications and workflow, for example. The perspectives management system allows various perspectives to be defined which save workflow steps and other information for a particular user. Perspectives may be used to save visual component positioning information and interactions based on workflow, for example. Perspectives allow relevant information to be presented to a user.

In certain embodiments, a patient record provides identification information, allergy and/or ailment information, history information, orders, medications, progress notes, flowsheets, labs, images, monitors, summary, administrative information, and/or other information, for example. The patient record may include a list of tasks for a healthcare practitioner and/or the patient, for example. The patient record may also identify a care provider and/or a location of the patient, for example.

In certain embodiments, an indication may be given of, for example, normal results, abnormal results, and/or critical results. For example, the indication may be graphical, such as an icon. The user may select the indicator to obtain more information. For example, the user may click on an icon to see details as to why a result was abnormal. The user may be able to view only certain types of results. For example, the user may view only critical results.

Filters and/or rules may be provided for views and/or categories. Ranges, such as values or dates, may be specified for data. Default views, categories, filters, rules, and/or ranges may be provided. In certain embodiments, default values may be modified by a user and/or based on operating conditions. In certain embodiments, new views, categories, filters, rules, ranges, etc., may be created by a user.

For example, a filter may be used to filter medical results data presented to a user according to one or more variables. For example, when a filter is selected by a user, a modification routine applies the filter to the results displayed to the user in the current view by removing from display all medical results that do not fall within the filter. As described above, a variable may be any data or information included in medical data. For example, a variable may include one or more of a type (or item) and/or range of laboratory test results, vital sign measurements, fluids administered to a patient, and/or fluids measured from a patient. A variable may include text from notes, laboratory reports, examination reports, one or more captions to a laboratory test result, vital sign measurement, and/or fluids administered to/measured from a patient, an order for a laboratory test, treatment and/or prescription, and/or a name. By specifying one or more limits on one or more variables, a user may create a filter to be applied to results presented in a results window.

In certain embodiments, a unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user may be authenticated at the unified user interface. Authentication at the unified user interface may propagate through the connected application(s) and/or system(s), for example.

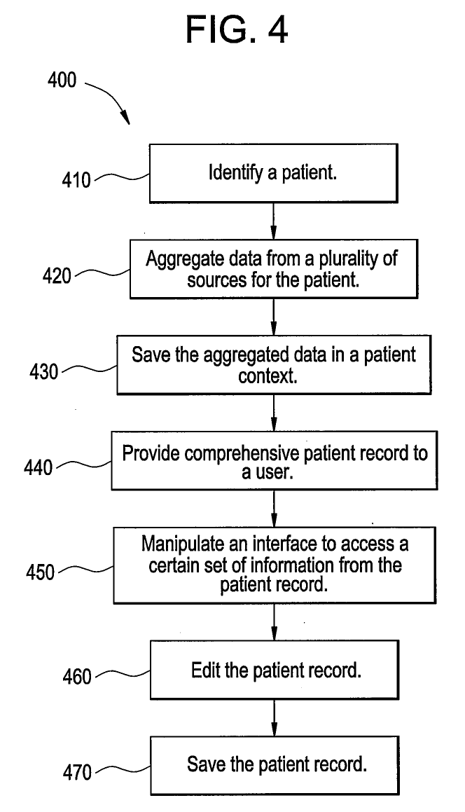

FIG. 4 illustrates a flow diagram for a method 400 for documentation of a patient lifetime in a patient record according to an embodiment of the present invention. At step 410, a particular patient is identified. For example, patient Mona Quinn is identified for creation of a comprehensive electronic patient record. At step 420, data is aggregated from a plurality of sources for the patient. For example, data for the identified or otherwise selected patient is retrieved from one or more sources, such as a PACS, RIS, EMR, HIS, etc., and aggregated or combined into a timeline or comprehensive view of patient data over the life of the patient.

At step 430, aggregated data is saved in a patient context. For example, a lifetime EMR for a patient may include the aggregated data. Alternatively, links to the component data may be saved with respect to an interface for later retrieval/use by a user or automated system, for example.

At step 440, the comprehensive patient record is provided to a user. For example, a user may view the comprehensive patient record and constituent data via a user interface such as a display, a touch screen, a viewing table with sensors, etc. At step 450, a user may manipulate the interface to access a certain set of information from the patient record. For example, a user may filter and/or provide search criteria to focus, drill down or otherwise navigate the patient data set.

At step 460, a user may edit the patient record. For example, a user may annotate (e.g., connect and/or group by lining with a line, circling, etc.) data points in the record. As another example, a user may open and edit one or more data points included in the patient record using one or more input sources such as a keyboard, touch screen, stylus, voice command, eye tracking, etc. A user may add and/or delete one or more data points in the record, for example. A user may tag or bookmark one or more data points for easier notice/access in later use, for example. At step 470, a user may save the patient record. The patient record may be saved to an information system, EMR, portable medium, smart card, barcode, etc. Thus, modifications/annotations to the record may be saved for later retrieval and/or other use.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more embodiments of the presently described invention provide, among other things, an improved method for presenting data in such a way that associations among data and/or events are graphically presented to a user. In doing so, users can view relationships and evolutions between data and/or events. In addition, users can avoid being confused by visual clutter caused by unrelated data or events. One particular application of the presently described technology is in the presentation of medical events and data included in a patient's EMR in such a way that associations among events and data related to one another and/or to a particular medical problem, hospital visit, encounter or medical test/examination, for example.

In certain embodiments, a timeline may be viewed and/or constructed using a system such as system 500 including at least one data storage 510 and at least one workstation 520. While three workstations 520 are illustrated in system 500, a larger or smaller number of workstations 520 can be used in accordance with embodiments of the presently described technology. In addition, while one data storage 510 is illustrated in system 500, system 500 can include more than one data storage 510. For example, each of a plurality of entities (such as remote data storage facilities, hospitals or clinics) can each include one or more data stores 510 in communication with one or more workstations 520.

As illustrated in system 500, one or more workstations 520 can be in communication with at least one other workstation 520 and/or at least one data storage 510. Workstations 520 can be located in a single physical location or in a plurality of locations. Workstations 520 can be connected to and communicate via one or more networks.

Workstations 520 can be directly attached to one or more data stores 510 and/or communicate with data storage 510 via one or more networks. Each workstation 520 can be implemented using a specialized or general-purpose computer executing a computer program for carrying out the processes described herein. Workstations 520 can be personal computers or host attached terminals, for example. If workstations 520 are personal computers, the processing described herein can be shared by one or more data stores 510 and a workstation 520 by providing an applet to workstation 520, for example.

Workstations 520 include an input device 522, an output device 524 and a storage medium 526. For example, workstations 520 can include a mouse, stylus, microphone and/or keyboard as an input device. Workstations 520 can include a computer monitor, liquid crystal display (“LCD”) screen, printer and/or speaker as an output device.

Storage medium 526 of workstations 520 is a computer-readable memory. For example, storage medium 526 can include a computer hard drive, a compact disc (“CD”) drive, a USB thumb drive, or any other type of memory capable of storing one or more computer software applications. Storage medium 526 can be included in workstations 520 or physically remote from workstations 720. For example, storage medium 526 can be accessible by workstations 520 through a wired or wireless network connection.

Storage medium 526 includes a set of instructions for a computer. The set of instructions includes one or more routines capable of being run or performed by workstations 520. The set of instructions can be embodied in one or more software applications or in computer code.

Data storage 510 can be implemented using a variety of devices for storing electronic information such as a file transfer protocol (“FTP”) server, for example. Data storage 510 includes electronic data. For example, data storage 510 can store EMRs for a plurality of patients. Data storage 510 may include and/or be in communication with one or more clinical information systems, for example.

Communication between workstations 520, workstations 520 and data storage 510, and/or a plurality of data stores 510 can be via any one or more types of known networks including a local area network (“LAN”), a wide area network (“WAN”), an intranet, or a global network (for example, Internet). Any two of workstations 520 and data stores 510 can be coupled to one another through multiple networks (for example, intranet and Internet) so that not all components of system 500 are required to be coupled to one another through the same network.

Any workstations 520 and/or data stores 510 can be connected to a network or one another in a wired or wireless fashion. In an example embodiment, workstations 520 and data store 510 communicate via the Internet and each workstation 520 executes a user interface application to directly connect to data store 510. In another embodiment, workstation 520 can execute a web browser to contact data store 510. Alternatively, workstation 520 can be implemented using a device programmed primarily for accessing data store 510.

Data storage 510 can be implemented using a server operating in response to a computer program stored in a storage medium accessible by the server. Data storage 510 can operate as a network server (often referred to as a web server) to communicate with workstations 520. Data storage 510 can handle sending and receiving information to and from workstations 520 and can perform associated tasks. Data storage 510 can also include a firewall to prevent unauthorized access and enforce any limitations on authorized access. For instance, an administrator can have access to the entire system and have authority to modify portions of system 500 and a staff member can only have access to view a subset of the data stored at data store 510. In an example embodiment, the administrator has the ability to add new users, delete users and edit user privileges. The firewall can be implemented using conventional hardware and/or software.

Data store 510 can also operate as an application server. Data store 510 can execute one or more application programs to provide access to the data repository located on data store 510. Processing can be shared by data store 510 and workstations 520 by providing an application (for example, a java applet). Alternatively, data store 510 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 510 can be implemented using a variety of devices for storing electronic information such as an FTP server. It is understood that the storage device can be implemented using memory contained in data store 510 or it may be a separate physical device. The storage device can include a variety of information including a data warehouse containing data such as patient medical data, for example.

Data storage 510 can also operate as a database server and coordinate access to application data including data stored on the storage device. Data storage 510 can be physically stored as a single database with access restricted based on user characteristics or it can be physically stored in a variety of databases.

In an embodiment, data storage 510 is configured to store data that is recorded with or associated with a time and/or date stamp. For example, a data entry can be stored in data storage 510 along with a time and/or date at which the data was entered or recorded initially or at data storage 510. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 510 is configured to store medical data for a patient in an EMR. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In another example, the medical data/events can include the name and/or results of an imaging procedure. Such imaging procedures include, but are not limited to, CT scans, MRI scans, photographs, tomographic images, and computer models, for example.

The medical data/events can also include a description of a medical visit. For example, the medical data/event can list the date and/or time of a visit to a hospital, doctor's office or clinic, as well as details about what tests, procedures or examinations were performed during the visit. In addition, the data/event can include results of the tests, procedures and examinations as described above. The data/event can include the names of all caregivers that came into contact or provided medical care to the patient during the visit. The data/event can also include information on the length of the visit, as well as any symptoms complained of by a patient and/or noted by a caregiver or other staff.

In another example, the medical data/events can include a description of a medical problem that a patient is experiencing. For example, an injury can be recorded as a medical problem, as well as any illnesses (chronic or otherwise) a patient is experiencing.

The medical data/events can also include details of a caregiver encounter. For example, the data/event can include information such as the date/time of an encounter with a doctor, nurse or other caregiver (such as a radiologist, for example). The data/event can include additional information such as what medical tests, examinations or procedures were performed on a patient by a specific caregiver. For example, if nurse “X” takes a blood sample from a patient, records the weight of a patient and tests the patient's blood pressure, then all of these tests and procedures, as well as the results, can be recorded as medical data/events associated with nurse X.

In another example, medical data/events can include a description and/or results of a medical procedure. For example, the name and outcome of a surgery or outpatient procedure can be recorded as a medical procedure.

Medical data/events can also include a description of any symptoms experienced by a patient. This information can be recorded as text or by a codification scheme. For example, medical data/events can include descriptions such as a headache, chest pains or dizziness.

The medical data/events stored in a patient's EMR can also include any biological analyses performed on the patient. For example, the data/events can include the numerical results of blood, enzyme or other fluid tests. In another example, the data/events can include a text description of the results of a biological analysis.

In another example, the medical data/events can include a finding by a caregiver. A finding can include any numeric and/or text-based description of a discovery or analysis made by the caregiver. For example, a radiologist can analyze a series of x-ray images of a patient and find a growth or tumor in the patient. The radiologist can then record his or her finding in a patient's EMR.

The medical data/events can also include one or more medications a patient is or has taken. The data can include the date, time, dosage and/or name of medication, for example.

The medical data/events can also include one or more acquisitions. An acquisition can include any actual data acquired and/or the date at which the data is acquired. For example, an acquisition can include the results and/or date/time at which results from a laboratory test were acquired.

One or more types of similar data/events is included in a category of data/events. In continuing with the above example, a category of medical data/events can include all “tests” (including all test results or “test results” being a separate category), “imaging procedures” (including all images obtained therefrom or “images” being a separate category), “visit,” “problems,” “encounters,” “medical procedures” (including all results or “medical procedure results” being a separate category), “symptoms,” “biological analyses” (including all results of such analyses or “biological analysis result(s)” being a separate category), “findings,” “medications,” and/or “results.”

While the above provides several examples of the types of medical data/events that can be used in accordance with embodiments of the presently described technology, it is to be understood that the presently described technology is not limited to the above data/events. In addition, while some types of information stored as medical data/events described above is repeated, it is to be understood that various medical data/events can be stored multiple times. For example, if a patient complains of a symptom to a caregiver during a particular office visit, the symptom can be recorded by itself and/or with additional information, such as the name of the caregiver and any procedures performed on the patient.

In an embodiment, the medical data/events include the actual information desired to be stored. Alternatively, the medical data/events can include a code representative of the actual information desired to be stored. For example, the codes provided by the International Statistical Classification of Diseases and Related Health Problems (“ICD”) can be stored in place of the actual information related to the medical data/event.

In operation, a user employs a workstation 520 to display, on an output device 524, a comprehensive patient record aggregated from data and/or events stored at one or more data storage 510. The workstation 520 facilitates filtering/search of the available data and provision of one or more associations among a plurality of the data and/or events visually represented to the user, for example. As described above, workstation 520 includes computer-readable storage medium 526 that itself comprises a set of instructions for workstation 520. The set of instructions can be embodied in one or more computer software applications or computer code. This set of instructions is used by workstation 520 to access and display data and/or events and one or more associations among a plurality of the data/events. Thus, at least one technical effect of the set of instructions is to aggregate and filter data from a plurality of disparate information systems so as to enable a user to quickly and easily review patient electronic medical record data.

The set of instructions includes one or more software routines. In an embodiment of the presently described technology, the set of instructions includes a display routine, a data routine and a filter routine. These routines operate to determine and display associations among related data/events on display device 522.

In certain embodiments, the set of instructions includes a user interface routine and a filter routine. The user interface routine displays an aggregated electronic patient record. The electronic patient record includes a plurality of data points related to a patient. The plurality of data points provides patient data aggregated from a plurality of information sources. The user interface routine provides access to and review of the plurality of data points within a single view. The filter routine filters the aggregated electronic patient record based on one or more terms provided by a user to generate filtered electronic patient record data displayable via the user interface routine.

In certain embodiments, data/events can be displayed by representing each of the data/events by a symbol on one or more timelines, for example. Timelines may include medical events belonging to particular categories, for example. These timelines are also referred to as timeline metaphors. Timeline metaphors can be used in EMR software applications to provide users with the ability to navigate through a patient's medical history chronologically. In many cases, every patient encounter with a caregiver or hospital is listed as a separate item on a timeline. For example, timelines may present medical events and/or data by illustrating the date and/or time at which the medical event or data occurred, was collected or was entered.

In an embodiment, each data/event is represented by a graphical symbol. The exact symbol used can differ in accordance with the presently described technology. In an embodiment, the same symbol is used for all similar data/events. For example, the same symbol can be used for all medical data/events in a category of data/events.

A timeline can include data/events from a given category presented in chronological order. The number of timelines therefore can change based on the number of categories of data/events to be presented.

In certain embodiments, a user can select which data is displayed. For example, using input device 522, the user can select one or more categories to be presented on output device 524. The display routine and the data routine can then obtain the data/events in the selected category(ies) and display the data/events as shown in a presentation on output device 524. In addition, the user can select the date and/or time range over which the data/events are to be presented in timelines.

In an embodiment, a user can scroll an icon over a symbol or data point and the display routine will cause additional information related to the symbol to be presented to the user. For example, a user can employ input device 522 to move an arrow displayed on output device 524 over a symbol. Once the arrow is over the symbol (or once the user “clicks” or otherwise selects the symbol using input device 522), additional information about the data/event represented by symbol can be presented by the display routine on output device 526. For example, the display routine can cause popup window to appear and present the actual data/event (or a portion thereof) represented by the symbol.

In certain embodiments, a filter may be created by a user. The filter is used to determine which symbols represent events/data that are associated with one another, if any.

The filter comprises one or more rules. These rules are compared to all or a subset of the events/data. If any of the events/data satisfy or match each of the rules, the events/data are considered to be associated with one another. Such events/data are referred to as associated events/data. If any of the events/data do not satisfy or match all of the rules, the events/data are considered to not be associated with one another.

In an embodiment, a user creates a filter by employing input device 522 to select one or more predefined rules that are displayed on output device 526. The selected rules are then included in the filter.

In another embodiment, a user employs input device 522 to select a predefined filter. The predefined filter is a filter previously created by a user and stored on a computer-readable memory such as data store 510 or storage medium 526, for example.

The rules can include any criteria useful to determine whether a given data/event or subset of data/events fall within, or satisfy, the rule. For example, a rule can be stated as all data/events collected and/or entered during a particular patient's visit to a hospital. All data/events that were collected and/or entered during that visit would therefore fall within the scope of this rule and therefore be considered associated data/events.

In another example, a rule can define a set of data/events that are normally related with one another. For example, a typical doctor's office visit for a physical involves several routine tests such as tests on blood pressure, weight, reflexes, and/or blood. A rule can set one or more criteria that would include all medical data/events in a patient's EMR that includes information about and the results for blood pressure tests, weight measurements, reflex test results and blood test results. This rule can then be applied to a patient's EMR to determine which medical data/events includes data from blood pressure tests, weight measurements, reflex test results and blood test results. This data is then considered to be associated data.

In another example, a rule can define one or more criteria that associate all data/events related to a single patient encounter or a selected time and/or date range. Such a criteria can state that all data/events that were collected and/or entered during that encounter or during the time and/or date range selected by the user.

Another example of a rule is one in which all data/events from a particular medical test or examination are associated with one another. For example, a rule can state that all data/events describing a test and the results of that test are associated. Such a rule would associate a description of a blood test and all chemical and biological analyses from that blood test as associated data/events.

In another example, a rule can define one or more criteria that associate all data/events collected and/or entered by one caregiver or group of caregivers and excludes all data/events collected and/or entered by all other caregivers. For example, such a rule can associate all test results collected by a particular nurse and exclude all test results entered by other nurses.

In another example, a rule can define one or more criteria that associate all data/events with a predefined association with a selected medical problem and/or medical procedure. For example, the data/events stored at data store 510 can have a predefined association with one another based on an underlying problem or test. The medical problem of diabetes could have predefined association with tests such as eye examinations, foot examinations, blood sugar test results, hemoglobin A1c results and urine tests, for example. A medical procedure such as a surgery can have a predefined association with one or more caregivers' names involved in the surgery and in the recovery from surgery, test results related to the surgery and/or related symptoms, for example. All data/events with such predefined associations can be considered associated data/events according to such a rule.

The predefined associations can be stored or recorded in a variety of manners. For example, metadata included in the actual data/events stored at data store 510 can include the predefined associations. In another example, the actual data/events can have the predefined associations recorded in the data itself. A relational database or table stored at data store 510 can also include the predefined associations, for example.

Once the filter is selected or created by a user, the filter is used to determine if any associations exist among the data/events displayed on output device 526. A filter routine can determine if any associations exist among the displayed data/events by applying the filter to the data/events. The filter routine can apply the filter by comparing the criteria defined by the rule(s) of the filter to the data/events displayed on output device 526. For example, the filter routine can apply the filter by searching through all or a subset of data/events stored at data store 510 and comparing the criteria of the filter rule(s) to the data/events.

In an embodiment, the filter routine determines that data/events are associated data/events only if each and every one of the criteria defined by the filter is matched or satisfied. For example, if one or more criteria are not met by a particular data/event, then that data/entry is not considered to be associated with the data/events that meet each of the criteria.

In another embodiment, the filter routine determines that data/events are associated data/events if a number of the criteria defined by the filter that is greater than a predefined threshold is matched or satisfied. For example, if a predefined threshold requires that 75% of the filter's criteria be met in order for the data/events to be associated data/events, any data/events that does not meet at least 75% of the criteria is not considered associated data/events. Conversely, all data/events that do meet at least 75% of the criteria are associated data/events, for example.

Once the associated data/events are determined, a visual representation of the associated data/events may be created. In an embodiment, a display routine causes a visual representation of the association among the associated data/events to appear on output device 526.

One or more embodiments of the presently described invention provide several advantages. In certain embodiments, information can be aggregated from a variety of sources and present to the user in a unified format. In certain embodiments, information may be searched and/or filtered based on one or more criteria. In addition, using embodiments of the presently described technology, relevant information can be accessed without the uncertainty of accessing unrelated data/events that occur in close proximity to related data/events.

Certain embodiments provide methods and systems providing clinical display and search capabilities for all of a patient's electronic medical record data from a variety of disparate information systems. Certain embodiments provide a fill clinical display and search functionality for a complete set of patient electronic medical record data from a variety of disparate information systems. Certain embodiments provide such aggregated and filtered data and functionality through a unified interface. For example, a worklist or browser queries all available enterprise hospital information systems and aggregates the data into a single, interactive window that displays all results and data points from a particular patient search. The worklist/browser can display information from Radiology, Cardiology, Pharmacy, Medication, Lab information systems, etc.

In certain embodiments, column headings for one or more searches can be user configurable to display metadata relevant to specific users. Column headings can filter the patient information via dynamic keystrokes and/or specific drop down menus related to each column heading, for example. For example, certain column headings allow users to filter based on specific type(s) of EMR patient data to display. Certain column headings allow users to filter data points based on date(s) and/or date range(s), for example. Certain embodiments allow filtering of data based on visit (e.g., last visit, last five visits, last “N” visits, etc.), for example. An ability to search and filter a patient's full electronic medical record helps enable physicians to fully visualize a full context to a patient's health or pathology, for example.

In certain embodiments, as a user navigates away from one patient, an interface system can automatically save the last state of the interface. Saved user interface context may include open windows, completed fields, positions in multi-step workflows, etc., for a patient chart or record. This “patient context” is stored and represented to the user as an icon within the interface and/or other context manager, for example. In order to get back to the patient context of any saved state, the user clicks on or otherwise selects the icon representing the last patient context within the software. By clicking a single button, the user is able to toggle back and forth between multiple patient contexts in a single session, thus helping to reduce an amount of effort and navigation to complete clinical tasks.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical navigation system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A user interface system displaying an electronic patient record, said system comprising:
a processor aggregating data relating to a patient from a plurality of information systems to form an aggregated electronic patient record;
a filter focusing the aggregated data based on one or more criteria; and
an output providing the focused data to a user.

2. The user interface system of claim 1, wherein said filter includes a search capability to search the aggregated data based on said one or more criteria and provide search results.

3. The user interface system of claim 1, wherein said one or more criteria are provided by at least one of a user and a system default parameter.

4. The user interface system of claim 1, wherein said processor automatically facilitates login to said plurality of information systems without user intervention.

5. The user interface system of claim 1, further comprising an input allowing a user to edit said data.

6. The user interface system of claim 5, wherein said input allows a user to create associations between data.

7. The user interface system of claim 1, wherein said output provides the focused data to a user via at least one of a display and a report.

8. The user interface system of claim 7, wherein said output provides the focused data in at least one of a tabular form and a timeline form.

9. A method for electronic patient data aggregation, said method comprising:
aggregating data for a patient from a plurality of systems without individual manual login by the user at each of the plurality of systems;
filtering said aggregated data based on one or more user-defined criteria entered through a unified interface to provide a filtered subset of said aggregated data; and
displaying said aggregated data via the unified interface.

10. The method of claim 9, wherein said filtering step further comprises facilitating a search of said aggregated data based on one or more terms entering using the unified interface.

11. The method of claim 9, wherein said filtering step comprises filtering based on a type of data.

12. The method of claim 9, wherein said filtering step comprises filtering based on information in metadata driven columns.

13. The method of claim 9, wherein said filtering step comprises filtering based on at least one of a date and time range.

14. The method of claim 9, wherein said filtering step comprises filtering based on patient visit.

15. The method of claim 9, wherein said displaying step further comprises displaying data in at least one of a tabular form and a timeline form.

16. The method of claim 9, further comprising editing said data via the unified interface.

17. A computer readable medium having a set of instructions for execution on a computer, said set of instructions comprising:
a user interface routine displaying an aggregated electronic patient record, said electronic patient record including a plurality of data points related to a patient, said plurality of data points providing patient data aggregated from a plurality of information sources, said interface routine providing access to and review of said plurality of data points within a single view; and
a filter routine filtering said aggregated electronic patient record based on one or more terms provided by a user to generate filtered electronic patient record data displayable via said user interface routine.

18. The computer readable medium of claim 17, further comprising a control routine facilitating navigation and manipulation of said electronic patient record to at least one of view and modify one or more of said plurality of data points in said record.

19. The computer readable medium of claim 17, wherein said filter routine facilitates a search of said aggregated electronic patient record based on one or more terms provided by a user.

20. The computer readable medium of claim 17, wherein said filter routine filters said aggregated electronic patient record based on at least one of a type of data, information in metadata driven columns of the aggregated electronic patient record, a date range, and patient visit.
